(19) United States
(12) Patent Application Publication
(10) Pub. No.: US 2002/0050085 A1
(43) Pub. Date: May 2, 2002

(54) System for and method of fund raising using shopping cart handle covers

(76) Inventor: Sam H. Durham, Valley, KS (US)

Correspondence Address: Fulbright & Jaworski L.L.P., 801 Pennsylvania Avenue, N.W., Washington, DC, 20004-2615, US

(21) Appl. No.: 09/916,404

(22) Filed: Jul. 18, 2001

Related U.S. Application Data
(60) Provisional application No. 60/219,052, filed on Jul. 18, 2000.

(51) Int. Cl. G09F 3/18

(52) U.S. Cl. 40/661.12

(57) ABSTRACT

The present invention includes a system for and a method of providing a handle cover which is used to solicit contributions for charitable organizations. The handle cover includes a tubular body formed from a flexible material, a horizontal slit along one side of the tubular body along a length of the tubular body, a notch cut in one end of the tubular body and an indicia which allows a portion of the proceeds of the sale to be directed to the charitable organization.

### FIELD OF THE INVENTION

The present invention is a handle cover for a shopping cart that dispenses advertisements such as coupons to consumers or is used to raise funds for charitable organizations. The handle cover is preferably made of a foam to aid gripping of the shopping cart.

### BACKGROUND OF THE INVENTION

It is important for retailers to present specials or savings to consumers in a manner that the consumer will be aware of the particular sale item and be reminded to purchase the item while shopping. Increasingly, retailers, and grocery supermarkets in particular, are using point of sale displays to advertise and dispense coupons or other information about products to consumers. A disadvantage is that success of point of sale displays rely in part on customer trafficking, i.e., if a consumer does not pass the display, the information desired to be presented will go unnoticed. New techniques and devices for presenting consumer information to consumers are desirable.

### SUMMARY OF THE INVENTION

The present invention includes a system for and a method of advertising on a handle cover which is purchased by a consumer. The handle cover includes a tubular body formed from a flexible material and includes a horizontal slit along the length of the tubular body and a notch cut in at least one end of the tubular body where the apex of the notch is located at the slit. Additionally, the tubular body includes a indicia located on the tubular body where the indicia includes information for the distribution of proceeds from sales of the cover.

In another embodiment the invention includes the steps of providing a flexible tubular body which is temporarily affixed to a shopping cart handle. The tubular body includes a slit lengthwise through the tubular body and a notch at one end of the tubular body. On the tubular body an indicia of a charitable organization is displayed and when the tubular body is sold a portion of the proceeds are directed to the charitable organization.

### BRIEF DESCRIPTION OF THE DRAWINGS

FIG. 1 shows a shopping cart having the handle cover of the invention placed over the shopping cart handle;

FIG. 2 is a detailed view of the handle cover of the invention, showing a coupon affixed thereto; and

FIG. 3 shows placement of the handle cover of the invention on a shopping cart.

### DESCRIPTION OF THE INVENTION

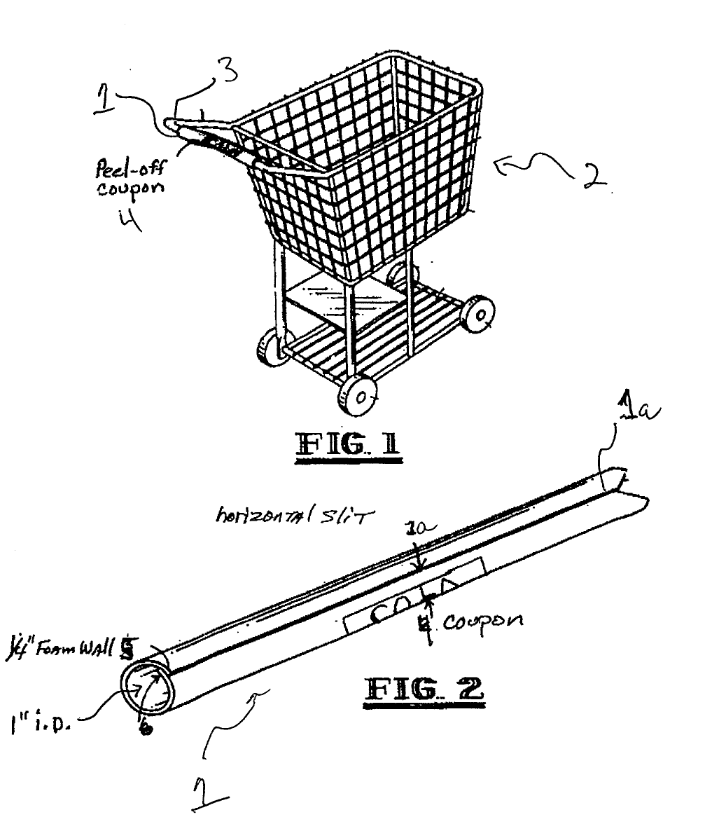

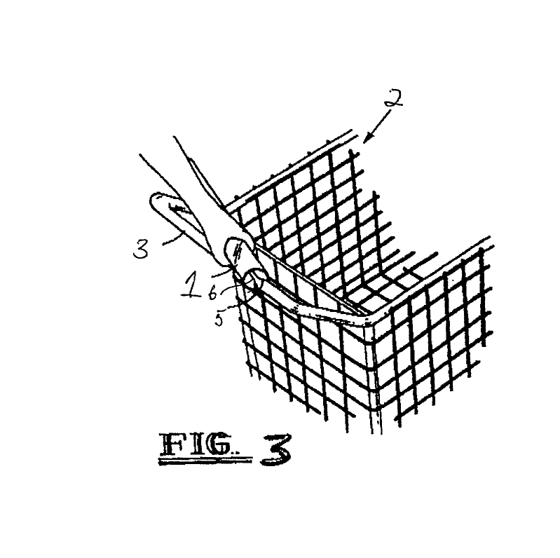

Referring to FIG. 1, handle cover 1 is adapted to be removably or permanently affixed to the handle 3 of a shopping cart 2. Handle cover 1 has one or more coupons 4 affixed thereto. As shown in more detail in FIG. 2, handle cover 1 has a horizontal slit 1a along its length which can be opened by pulling the adjacent edges 5, 6 apart so that the cover can be placed over shopping cart handle 3. FIG. 3 is a detailed view of how the handle cover 1 is affixed over the shopping cart handle 3 to cover all or a portion of the shopping cart handle. Handle cover 1 can be made of any flexible tubular material, but is preferably foam or plastic cover lined with foam on its inner surface to provide a comfortable grip for the consumer. The inside diameter of the tubular material is approximately 2.54 cm (approx. one inch), but may be any size to adapt to the shopping cart handle. At least one coupon 4 is affixed to an outer surface of the handle cover, and is peelably removable by the consumer.

Other informational products may be affixed to the outer surface of handle cover 1 in addition to, or in place of, coupons, e.g., nutritional information about certain products, copromotional information, recipes or other types of advertisements. Alternatively, removable blank paper may be peelably attached to the device for consumers to take notes thereon. A writing utensil may also be provided and attached with a string or other means for the consumer's use.

In preferred embodiments, the handle cover is made of polyethylene foam material, slit horizontally and cut to various lengths to fit different width shopping cart handles, i.e., 16″, etc. the foam will have a wall thickness of 0.25 to 0.30 and an inside diameter (i.d.) of 1″. Preferably, coupon 4 is approximately 2″×5″ and made of an acetate base with an adhesive backing and a peeloff coupon from this base. Any type of adhesive may be used provided it is peelably removably so that the consumer can remove the coupon for use.

Handle cover 1 is preferably centered so that coupon 4 or other advertisement is visible to the consumer throughout the duration of the shopping visit.

In another embodiment of the present invention, handle cover 1 may be used in fund raising activities by indicating on the handle cover 1 the charitable organization which will receive the funds. The charitable organization may be identified by replacing coupon 4 with the indicia or adding the indicia to handle cover 1 in a different location. For example if the Children's Miracle Network wishes to solicit contributions, a retailer such as Walmart may sell handle cover 1 to customers and direct a portion of the profits to the Children's Miracle Network. Advertisements for the handle cover will emphasize that a portion of the proceeds will be donated to the charitable organization. A bar code may be added to the handle cover and information obtained from the bar code may be used to ensure a portion of the profits are directed to the Children's Miracle Network.

Other embodiments of the invention will be readily apparent to those skilled in the art and are intended to be within the scope and spirit of the invention.

What is claimed is:

1. A cover for a handle of a shopping cart comprising:
a tubular body formed from a flexible material;
a horizontal slit along one side of said tubular body along a length of said tubular body;
a notch cut in at least one end of said tubular body, an apex of said notch located at said slit in said tubular body; and
indicia on said tubular body, said indicia including information for distribution of proceeds from a sale of said cover.

2. The cover of claim 1, further comprising:
informational products affixed to said outer surface of said tubular body.

3. The cover of claim 2, wherein said informational products includes nutritional information.

4. The cover of claim 2, wherein said informational products includes a recipe.

5. The cover of claim 1 further comprising:
blank paper removably affixed to said outer surface of said tubular body.

6. The cover of claim 5 further comprising:
a writing utensil attached to said tubular body.

7. The portable cover of claim 1 wherein said indicia further comprises a computer readable code indicative of an intended recipient of aid proceeds.

8. A method of soliciting donations to a charitable organization said method including the steps of:
providing a flexible tubular body to be temporarily affixed to a shopping cart handle, said tubular body including a (i) lengthwise slit through said tubular body and (ii) a notch on one end of said tubular body; and
displaying an indicia of said charitable organization on an outer surface of said tubular body;
selling said tubular body with said indicia displayed; and
directing a portion of profits relating to said sale to said charitable organization.

9. The method of claim 8 further including the step of:
affixing informational products to said outer surface of said tubular body.

10. The method of claim 9 wherein said step of affixing informational products includes the step of affixing nutritional information to said tubular body.

11. The method of claim 9 wherein said step of affixing informational products includes the step of affixing recipes to said tubular body.

12. The method of claim 8 further including a step of:
providing blank paper removably affixed to said outer surface of said tubular body.

13. The method of claim 12 further including a step of:
attaching a writing instrument to said tubular body.

14. The method of claim 8 further including a step of: including
a computer readable code indicative of an intended recipient of said proceeds.
